(19) United States
(12) Patent Application Publication
(10) Pub. No.: US 2006/0288147 A1
(43) Pub. Date: Dec. 21, 2006

(54) Integrated portable medical measurement apparatus

(76) Inventor: Hsiang-Chi Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/452,347

(22) Filed: Jun. 14, 2006

(30) Foreign Application Priority Data
Jun. 17, 2005 (TW) 094210262

(51) Int. Cl. G06F 13/14

(52) U.S. Cl. 710/305

(57) ABSTRACT

An integrated portable medical measurement apparatus is provided, including a digital medical measurement instrument and a USB media interface device. The digital medical measurement instrument includes a measuring module and an interface unit. The measuring module is for measuring the blood pressure, heartbeat rate, body temperature, blood sugar, and so on, and outputs the measured data through the interface unit. The USB media interface device includes an interface unit and a USB media module. The interface unit is connected to the interface unit of the measurement instrument to form a bi-directional data transmission channel between the digital medical measurement instrument and the USB media interface device. The USB media module is externally connected to a USB multimedia device so that the measured data from the digital medical measurement instrument can be stored in the USB multimedia device. Alternatively, the data stored in the USB multimedia device can be downloaded to the digital medical measurement instrument for comparison or analysis. This enables the present invention to be an integrated portable medical measurement apparatus having the bi-directional data transmission capacity, data storage and comparison and analysis.

### BACKGROUND OF THE INVENTION

1. Field of the Invention

The present invention relates to an integrated portable medical measurement apparatus and, more particularly, to an apparatus for measuring human physical data and having a capability for uploading measured data to and downloading stored data from a USB multimedia device.

2. The Related Art

The health self-management of the physical conditions is one of the medical treatment methods for severe or chronicle illness. For example, patients suffering heart-related conditions or diabetics must monitor their heartbeat rate, blood pressure and the other related physical measurements to prevent unexpected changes in the conditions. However, the conventional analog or digital medical measurement instruments are usually unable to work with stand-alone information systems, such as home PC, notebook PC, or flash memory stick, and PDA, for storing and retrieving data. As the remote diagnosis is getting more attention, the capability for the medical measurement instruments to communicate with other information processing or communication system is imperative for the purpose of health self-management.

In addition, the conventional digital medical measurement instruments have a limited memory capacity to store the measured data. As the chronicle illness patients may require performing several measurements several times on a daily basis, the measured data may accumulate to a large amount to exceed the storage capacity of the instruments, especially for a long-term storage purpose. Therefore, the conventional measurement instrument cannot provide the memory capacity to meet the demands of long-term tracking and analysis.

### SUMMARY OF THE INVENTION

The present invention is provided to overcome the aforementioned drawbacks of the conventional medical measurement instruments. The primary object of the present invention is to provide an integrated portable medical measurement apparatus, including a digital medical measurement instrument and a USB media interface device. The digital medical measurement instrument includes a measuring module and an interface unit. The measuring module is for measuring the blood pressure, heartbeat rate, body temperature, blood sugar, and so on, and outputs the measured data through the interface unit. The USB media interface device includes an interface unit and a USB media module. The interface unit is connected to the interface unit of the measurement instrument to form a bi-directional data transmission channel between the digital medical measurement instrument and the USB media interface device. The USB media module is externally connected to a USB multimedia device so that the measured data from the digital medical measurement instrument can be stored in the USB multimedia device. Alternatively, the data stored in the USB multimedia device can be downloaded to the digital medical measurement instrument for comparison or analysis. This enables the present invention to be an integrated portable medical measurement apparatus having the bi-directional data transmission capacity, data storage and comparison and analysis.

The present invention is to improve the limitation of the conventional technology, which does not meet the long term and large amount storage requirements. In addition, the present invention can be applied to the flash memory sticks, notebook PC, mobile phone, PDA, digital camera, audio recording pen, or home PC for bi-directional data transmission so that the patients or the doctors can perform the tracking or diagnosis remotely and more conveniently.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a system block diagram of a first embodiment of the present invention;

FIG. 2 is a system block diagram of a second embodiment of the present invention;

FIG. 3 is a system block diagram of a third embodiment of the present invention; and

FIG. 4 is a system block diagram of a fourth embodiment of the present invention.

### DETAILED DESCRIPTION OF THE PREFERRED EMBODIMENT

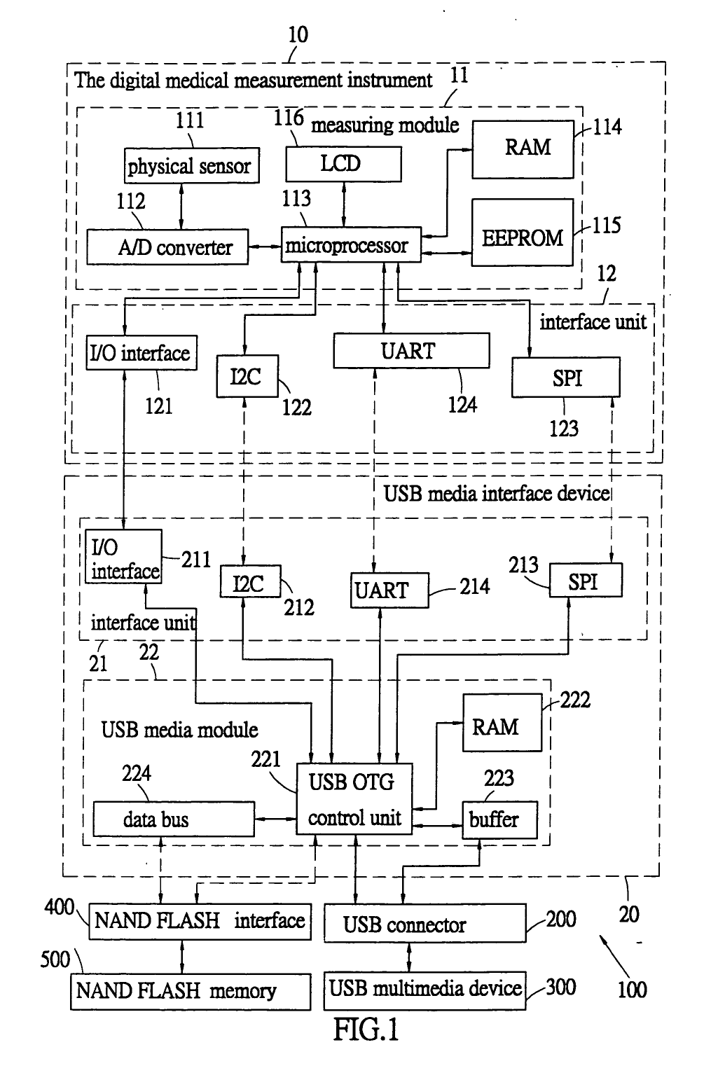

With reference to the drawings and in particular to FIG. 1, which shows a first embodiment of an integrated portable medical measurement apparatus 100 in accordance with the present invention. The integrated portable medical measurement apparatus 100 comprises a digital medical measurement instrument 10 and a USB media interface device 20. The digital medical measurement instrument 10 further comprises a measuring module 11 and an interface unit 12. The measuring module 11 is not limited to any specific type. This embodiment of the present invention includes a physical sensor 111, an A/D converter 112, a microprocessor 113, a RAM 114, an EEPROM 115, and an LCD 116. The physical sensor 111 detects and transmits human physical analog signals, such as blood pressure, heartbeat, temperature, and so on. The A/D converter 112 is connected to the physical sensor 111 for converting the detected analog signals into digital signals.

The microprocessor 113 is connected to the A/D converter 112 for receiving the converted digital signals. The microprocessor 113 includes a data storage format control, and programs for uploading and downloading data so that the received digital signals can be formatted, uploaded or stored.

The RAM 114 is connected to the microprocessor 113 to provide temporary data storage for the programs on the microprocessor 113 during the formatting, uploading and downloading.

The EEPROM 115 is connected to the microprocessor 113 to provide the temporary data storage for the formatted digital data outputted by the microprocessor 113.

The LCD 16 is connected to the microprocessor 113. The LCD 116 is not limited to any specific type. The embodiment in FIG. 1 shows a touch-panel LCD. Through the touch-panel LCD 116, the user can input the instructions, such as measuring, storing, uploading or downloading instructions to the microprocessor 113 so that the microprocessor 113 can provide the digital data, such as blood pressure, heartbeat, and so on, for display.

The Interface unit 12 is connected to the measuring module 11. The interface unit 12 is not limited to any specific type. The embodiment of FIG. 1 includes an I/O interface 121, an I2C 122, an SPI 123, and an UART 124, all connected to the microprocessor 113 of the measuring module 11, respectively, so that the measuring module 11 can execute interface instruction transmission, or bi-directional data transmission.

The USB media interface device 20 includes an interface unit 21 and a USB media module 22. The interface unit 21 corresponds to the interface unit 12 of the digital medial measurement instrument 10. The interface unit 21 includes an I/O interface 211, an I2C 212, an SPI 213, and an UART 214, all connected to the corresponding I/O interface 121, I2C 122, SPI 123 and UART 124 of the interface unit 12 so that the digital medical measurement instrument 10 and the USB media interface device 20 can perform bi-directional data transmission.

The USB media module 22 includes a USB OTG control unit 221, a RAM 222, a buffer 223, and a data bus 224. The USB OTG control unit 221 includes programs for controlling USB interface transmission, data format conversion, and data uploading and downloading. The USB OTG control unit 221 is connected to the I/O interface 211, an I2C 212, SPI 213 and UART 214 of interface unit 21 for receiving data from and transmitting data to the digital medical measurement instrument 10.

The RAM 222 is connected to the USB OTG control unit 221 for providing temporary data storage for the programs on the USB OTG control unit 221.

The buffer 223 is connected to the USB OTG control unit 221 for providing data buffer for the USB OTG control unit 221 during USB interface transmission. The USB OTG control unit 221 and the buffer 223 are connected externally to a USB connector 200, which provides connection to a USB multimedia device 300. The USB multimedia device 300 is a multimedia device having a USB interface, such as flash memory stick, notebook PC, PDA, mobile phone, or home PC. The USB multimedia device 300 can execute data transmission to or from the digital medical measurement instrument 10 through the USB OTG control unit 221 and the buffer 223 for display, comparison and analysis.

The data bus 224 is connected to the USB OTG control unit 221 to provide NAND FLASH interface data transmission. The data bus 224 and the USB OTG control unit 221 are connected externally to a NAND FLASH interface 400, which provides connection to a NAND FLASH memory 500. Through the data bus 224 and the USB OTG control unit 221, the NAND FLASH memory 500 can execute data transmission to or from the digital medical measurement instrument 10 for display, comparison and analysis.

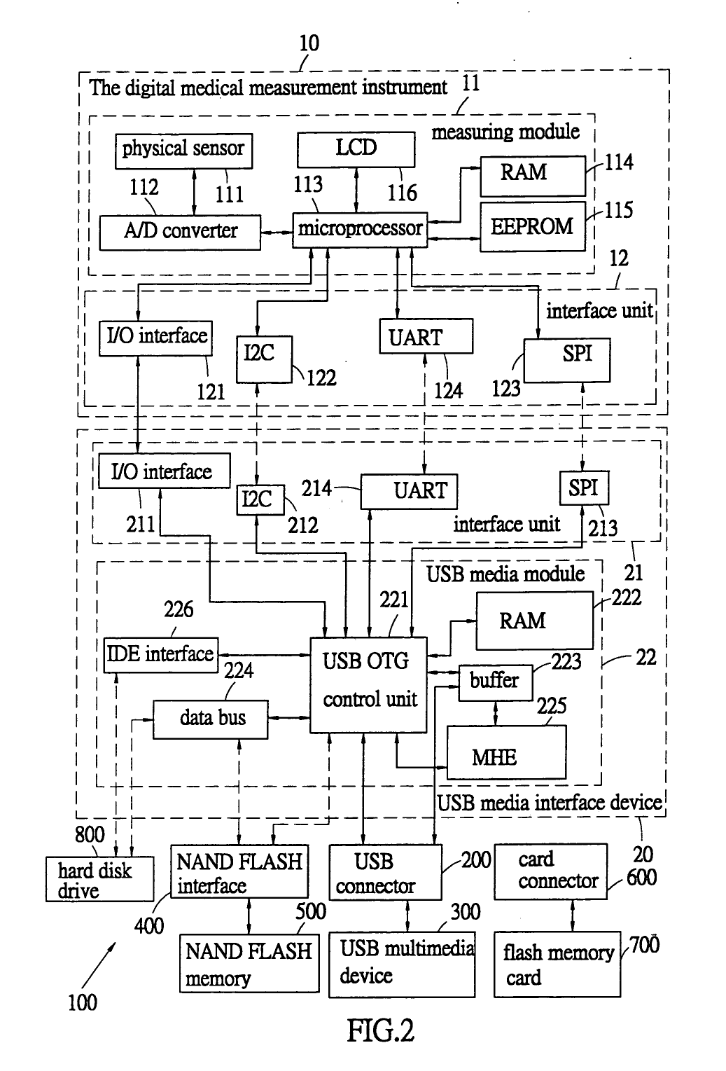

FIG. 2 shows a second embodiment of the present invention. Compared to the embodiment shown in FIG. 1, the USB OTG control unit 221 and the buffer 223 of the second embodiment are connected to an MHE 225, which is connected externally to a card connector 600. The card connector 600 provides connection to a flash memory card 700. The flash memory card 700 can execute data transmission to or from the digital medical measurement instrument 10 through the USB OTG control unit 221 and the buffer 223 for display, comparison and analysis.

The USB OTG control unit 221 of FIG. 2 is connected to an IDE interface 226. The IDE interface 226 and the data bus 224 are connected externally to a hard disk drive 800. The hard disk drive 800 can execute data transmission to or from the digital medical measurement instrument 10 through the IDE interface 226, the USB OTG control unit 221, and the data bus 224 223 for display, comparison and analysis.

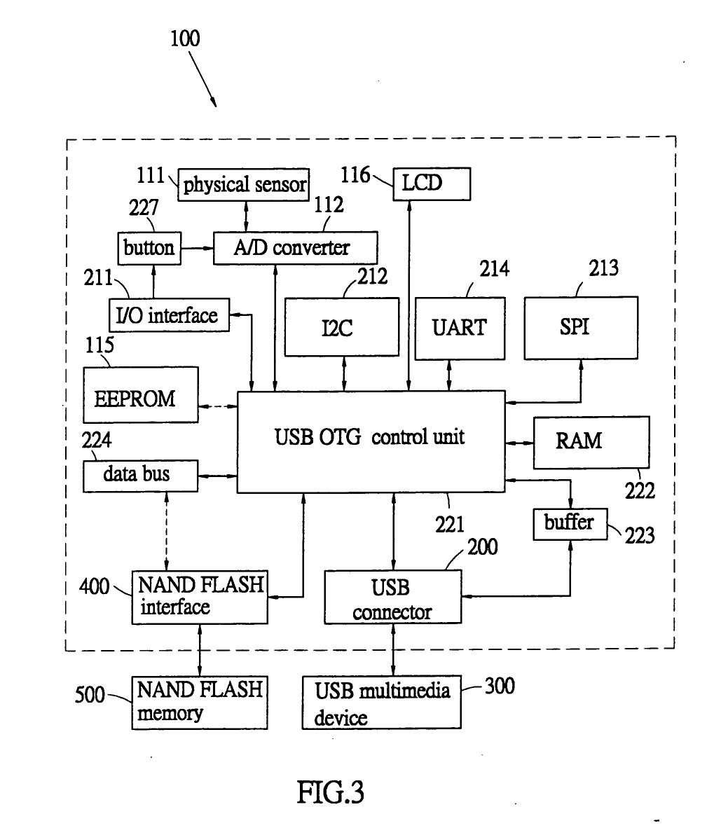

FIG. 3 shows a third embodiment of the present invention. Compared to the embodiment shown in FIG. 1, the functionalities of microprocessor 113 are integrated into the USB OTG control unit 221, and the structure and the functionalities of the I/O interface 121, the I2C 122, the SPI 123, and the UART 124 of the interface unit 12 are integrated into those of the I/O interface 211, the I2C 212, the SPI 213, and the UART 214 of the interface unit 21. A button 227 is connected between the I/O interface 211 and the A/D converter 112. Through the press of the button 227, the user can input the operation instructions to the USB OTG control unit 211 so that the USB OTG control unit 211 can execute the data transmission to the USB multimedia device 200 and the NAND FLASH memory 500. In this way, the digital medical measurement instrument 10 and the USB media interface device 20 are integrated into one complete unit.

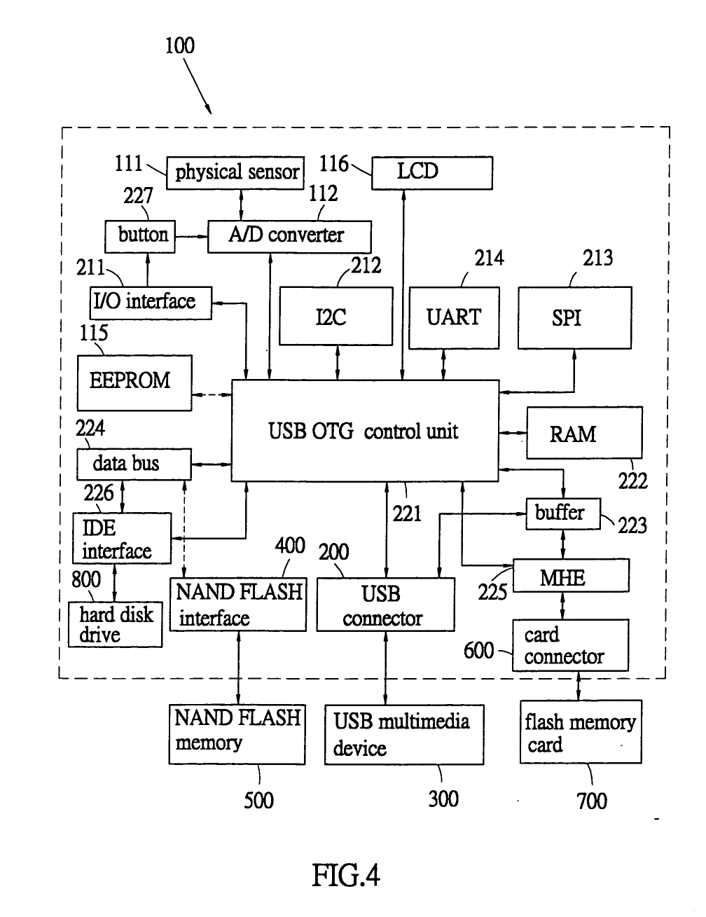

FIG. 4 shows a fourth embodiment of the present invention. Compared to the embodiment shown in FIG. 2, the functionalities of the microprocessor 113 are integrated into the USB OTG control unit 221, and the structure and the functionalities of the I/O interface 121, the I2C 122, the SPI 123, and the UART 124 of the interface unit 12 are integrated into those of the I/O interface 211, the I2C 212, the SPI 213, and the UART 214 of the interface unit 21. A button 227 is connected between the I/O interface 211 and the A/D converter 112. Through the press of the button 227, the user can input the operation instructions to the USB OTG control unit 211 so that the USB OTG control unit 211 can execute the data transmission to the USB multimedia device 200, the NAND FLASH memory 500, the flash memory stick 700, and the hard disk drive 800. In this way, the digital medical measurement instrument 10 and the USB media interface device 20 are integrated into one complete unit.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. An integrated portable medical measurement apparatus, comprising:
a medical measurement instrument, comprising a measuring module and a first interface unit, the measuring module sensing and outputting human physical measurements, the first interface unit performing bi-directional data transmission for measured data; and
a USB media interface device, comprising a second interface unit and a USB media module, the second interface unit connected to the first interface unit of the digital medical measurement instrument for bi-directional data transmission between the digital medical measurement instrument and the USV media interface device, the USB media module selectively performing USB interface transmission and being connected externally to a USB multimedia device for bi-directional data transmission of the measured data between the USB multimedia device and the measuring module of the digital medical measurement instrument.

2. The apparatus as claimed in claim 1, wherein the measuring module of the digital medical measurement instrument comprises:
a physical sensor, for sensing and outputting analog data of human physical conditions;
an A/D converter, connected to the physical sensor for converting the analog data to digital data;
a microprocessor, connected to the A/D converter, for receiving the converted digital data, performing data format conversion of the received digital data, and controlling transmission and storing of the digital data;
a RAM, connected to the microprocessor, for providing temporary data storage to the microprocessor during data format conversion, and data transmission;
an EEPROM, connected to the microprocessor, for providing temporary storage to the digital data outputted by the microprocessor after data format conversion; and
an LCD, connected to the microprocessor, for displaying the data received by the microprocessor.

3. The apparatus as claimed in claim 2, wherein the LCD is a touch-panel LCD.

4. The apparatus as claimed in claim 1, wherein the first interface unit of the digital measurement instrument comprises a first I/O interface, a first I2C, a first SPI, and a first UART.

5. The apparatus as claimed in claim 1, wherein the second interface unit of the USB media interface device comprises a second I/O interface, a second I2C, a second SPI, and a second UART.

6. The apparatus as claimed in claim 1, wherein the USB media module of the USB interface device comprises:
a USB OTG control unit, connected to the second interface unit of the USB media interface device;
a RAM, connected to the USB OTG control unit, for providing temporary data storage to the USB OTG control unit;
a buffer, connected to the USB OTG control unit, for providing data buffer to the USB OTG control unit during USB interface transmission; and
a data bus, connected to the USB OTG control unit, for providing NAND FLASH interface data transmission.

7. The apparatus as claimed in claim 6, wherein the USB OTG control unit and the buffer are externally connected to a USB connector.

8. The apparatus as claimed in claim 6, wherein the USB OTG control unit and the data bus are externally connected to a NAND FLASH interface.

9. The apparatus as claimed in claim 6, wherein the USB OTG control unit and the buffer are connected to an MHE.

10. The apparatus as claimed in claim 9, wherein the MHE is connected externally to a card connector.

11. The apparatus as claimed in claim 10, wherein the card connector is connected to a flash memory card.

12. The apparatus as claimed in claim 6, wherein the USB OTG control unit is connected to an IDE interface.

13. The apparatus as claimed in claim 12, wherein the IDE interface is connected to a hard disk drive.
